(19) United States
(12) Patent Application Publication
(10) Pub. No.: US 2018/0298181 A1
(43) Pub. Date: Oct. 18, 2018

(54) COMPRISING METHYL METHACRYLATE FOR MAKING OPTICAL DEVICE FRAMES, IN PARTICULAR GLASS FRAMES AND GLASSES HAVING FRAMES MADE OF SUCH A MATERIAL

(71) Applicant: ElkaR&D S.r.l., Agrate Brianza (MB) (IT)

(72) Inventors: Davide COLLINI, Roma (IT); Massimo VILLA, Lecco (IT); Marco TORTI, Concorezzo (MB) (IT)

(21) Appl. No.: 15/569,426

(22) PCT Filed: Apr. 27, 2016
(86) PCT No.: PCT/IB2016/052389

§ 371 Date: Oct. 26, 2017

(30) Foreign Application Priority Data
Apr. 29, 2015 (IT) MI2015A000612

(51) Int. Cl. C08L 33/12; G02C 5/00; B29D 12/02

(52) U.S. Cl. CPC C08L 33/12; G02C 5/008; B29K 2033/12; C08L 2205/06; B29D 12/02

(57) ABSTRACT

The present invention relates to a process for the preparation of a decorated polymeric material having a copolymer methyl methacrylate (MMA), a copolymer alkyl methacrylate or alkyl acrylate, and an impact resistance modifier. The invention also includes the polymeric material preferably colored and/or decorated obtained in the form of a plate, and to the use thereof, in particular in the field of glass frames or in jewelry.

The present invention relates to the use of a polymeric material based on a methyl methacrylate copolymer and a C₂-C₁₆ alkyl acrylate or methacrylate and at least one impact modifier polymer for making optical devices, preferably glass frames.

In particular, the present invention relates to the use of a polymeric material as defined for the realization of optical devices, in particular for glass frames, wherein the polymeric material is obtainable by copolymerization of a methyl methacrylate copolymer (MMA), with a alkyl methacrylate or alkyl acrylate copolymer, in the presence of at least one of impact resistance modifier.

The invention also relates to glasses having a frame made with the polymeric material mentioned above.

### BACKGROUND ART

The most used plastic materials in the production of glass frames are: cellulose acetate, the modified nylon, epoxy resins, polycarbonate (PC), the polyarylates and polymethyl methacrylate (PMMA). Such plastic materials, both thermoplastic and thermosetting, although widely used for a long time, often are not very suitable to satisfy the demands of the market always looking for new, inexpensive materials also characterized by decorations and unique optical effects. Said plastic materials can be realized in the form of plates, allowing, in this way, the use of well-established machining and thermoforming methods for making also valuable glass frames. However, a lot of technical and realization issues related to the selected polymeric material remain. For example, cellulose acetate, while being easy to work and characterized by a high impact resistance, is a rather expensive material. Moreover, cellulose acetate, to meet the needs of flexibility required by the plates used in the production of frames for glasses and in consideration of the fact that the melting temperature of this thermoplastic material is very close to the temperature of decomposition, contains a high amount of external plasticizers which can also exceed 30%. Such plasticizers are, mainly, phthalate-based such as diethyl phthalate and dimethoxy ethyl phthalate, which in addition to their discussed toxicity, reduce the possibility of making glasses, for example, with polycarbonate lenses as they may cause crazing phenomena on the same lenses. More recently, the use of plasticizers different from phthalates, of natural origin, used by some major manufacturers of cellulose acetate plates, seems to solve this issue. However, their use is often related to an increase of the price of the plates. For example, WO2012004727, and US 20130133549 describe cellulose acetate-based plastic materials, further comprising one or more plasticizers, used in the production of glass frames.

Nylon is used in the production of glass frames as well, but, despite being remarkably durable and flexible, it is difficult to “adjust” on the face of the wearer and it is mainly produced in dark colors. Due to its flexibility, it is mainly used in the production of frames for sports glasses. New types of modified nylon can be easier decorated, but they do not reach the color variability, for example, of acetate.

Special epoxy resins are also commercially available, developed for this particular use, which are lighter than cellulose acetate and very impact resistant. However, the frames made with this material are difficult to adjust because the material may return to its original shape. For example, if the glasses are left on the car dashboard on a hot day, there is the risk that they return to their original form, i.e. to that of the mold used to produce them, losing in this way the adjustment performed by the optician (memory). Such resins specially formulated for this use are thermosetting and hardly available as a plate. For a general reference, see for example U.S. Pat. No. 3,708,567 in which a method for the production of glass frames using a polymeric material based on epoxy, polyester or polyurethane resins is described.

Also the polycarbonate (PC) worked by injection is available in plates, but it is scarcely used. Even if the polycarbonate glasses are greatly resistant to impact, they are scarcely resistant to solvents and to ultraviolet radiation. Furthermore, since the PC is produced by extrusion, it is difficult to decorate in a varied manner and it is, therefore, mostly employed in the production of safety glasses. Furthermore, it must be taken into account that even glasses produced with PC are difficult to adjust because in order to reach the visco-elastic state it is necessary to use a very high temperature.

Therefore, the need is evident, especially for the market of plates used in the production of glass frames, of a product that is innovative, inexpensive, stable, biocompatible, and characterized by a sufficient flexibility and resistance to impact, to additives of lotions, to perspiration and the like. There is also the need to obtain a material which, in addition to the above mentioned features, it is also versatile in the possibility of realizing varied and innovative colorations and decorations, even in small quantities without the use of costly molds.

The Applicants have now found that these needs can be solved by using a polymeric material based on a methyl methacrylate copolymer and a C₂-C₁₆ alkyl acrylate or methacrylate and at least one impact modifier polymer. Such material is obtained by mass casting and copolymerization of a mixture containing a methyl methacrylate comonomer and a C₂-C₁₆ alkyl acrylate or methacrylate comonomer, in the presence of at least one impact modifier polymer, said process further comprising a final step of thermal stabilization at a temperature comprised between 100° C. and 140° C. Surprisingly, the material thus obtained, further than being decorated in varied ways and with different techniques, shows unique chemical-physical characteristics in terms, for example, of free polymer, solvent resistance and Vicat temperature, which make it particularly useful in the production of glass frames, for example, but not only, for prescription and sun type glasses.

### SUMMARY OF THE INVENTION

Therefore, in a first aspect, the present invention refers to the use of a polymeric material based on a methyl methacrylate copolymer and a C₂-C₁₆ alkyl acrylate or methacrylate and at least one impact modifier polymer for making optical devices, preferably glass frames.

The above mentioned polymeric material is obtainable by a preparation process comprising the mass casting and the copolymerization of a methyl methacrylate (MMA) comonomer and a C₂-C₁₆ alkyl acrylate or methacrylate comonomer, in the presence of at least one impact modifier polymer; said process further comprising a step of thermal stabilization at a temperature comprised between about 100° C. and 140° C.

In a further aspect, said polymeric material is obtained (or obtainable) by the above mentioned process, preferably in the form of a plate. In a preferred embodiment, said polymeric material may be obtained opaque, colored or decorated, even more preferably by means of a mass decoration, or a three-dimensional technique, or by transfer of digital images through thermal sublimation.

According to a further aspect, the invention also relates to glasses, preferably of prescription and/or sun and/or protective type, made with the above mentioned polymeric material.

### BRIEF DESCRIPTION OF DRAWINGS

FIG. 1: Example of sunglasses, having a matte frame made with the polymeric material of the invention, added with polystyrene.

FIG. 2: Example of glasses, having a variously decorated frame made with the polymeric material of the invention, obtained by means of decoration for mass inclusion of a PVC film.

### DETAILED DESCRIPTION

The term “Vicat temperature” means the softening point, known in materials science as a particular thermodynamic state at which a material begins to modify its aggregation state from solid to fluid. For a general reference see, for example, http://it.wikipedia.org/wiki/Punto_di_rammollimento.

The term “Tg” means the glass transition temperature below which an amorphous material behaves as a glassy solid. For a general reference see, for example, http://it.wikipedia.org/wiki/Temperatura_di_transizione_vetrosa.

The term “% by weight” (w/w) indicates the amount of the individual component with respect to the final weight of the mixture.

The term “C₂-C₁₆ alkyl” indicates an alkyl residue containing 2 to 16 linear or branched carbon atoms, for example: ethyl, n-propyl, isopropyl, n-butyl, iso-butyl, tert-butyl and the like.

The term “free monomer” of the polymeric material obtained by the process of the invention, refers to the sum of the concentrations of the methacrylate (MMA) comonomer and the second butyl methacrylate comonomer determined by gas chromatography and measured after the stabilizing heat treatment of the present process.

As mentioned above, the present invention relates to the use of a polymeric material based on a methyl methacrylate copolymer and a C₂-C₁₆ alkyl acrylate or methacrylate and at least one impact modifier polymer for making optical devices, preferably glass frames.

Such a polymeric material is obtainable by a preparation process comprising the copolymerization of a methyl methacrylate (MMA) copolymer, admixed with a C₂-C₁₆ alkyl acrylate or methacrylate copolymer, in the presence of at least one impact resistance modifier, said process being characterized in that it comprises a further step of thermal stabilization at a temperature comprised between 100° C. and 140° C. With the method of mass copolymerization according to the present process, the polymer obtained is of the random type, i.e. the final polymeric material is a mixture of copolymers with different compositions due to the conditions and the process steps themselves, as described below in detail.

The present process allows to obtain a polymeric material in the form of a plate, which offers a series of advantages, among which, the ability to be decorated or colored in a varied manner, the substantial absence of external plasticizers, a high biocompatibility and other advantages as illustrated below.

In particular, in one embodiment, the process for the preparation of the polymeric material suitable for the uses of the present invention, comprises the steps of:

a) mixing of a methyl methacrylate (MMA) comonomer with a second comonomer selected from C₂-C₁₆ alkyl acrylate or methacrylate;

b) addition of a polymeric impact modifier agent, preferably at a temperature comprised between about 40° C. and 60° C.;

c) optional addition of a crosslinking agent, preferably polymeric;

d) addition of at least one coloring and/or opacifying and/or decorative effect additive, for example selected from: dyes, pigments, coloring resins, natural and/or synthetic fibers and the like;

e) mass casting of the polymeric mixture thus obtained and subsequent copolymerization, preferably at a temperature comprised between about 60° C. and 120° C.;

f) stabilizing heat treatment at a temperature comprised between about 100° C. and 140° C.

Initially (step a), a first methyl methacrylate comonomer with a second comonomer selected from: C₂-C₁₆ alkyl acrylate or preferably alkyl methacrylate, or even more preferably n-butyl methacrylate are contacted with each other, for example by mechanical mixing. The methyl methacrylate (first comonomer, also referred to as MMA) is used in the process of the invention preferably in amounts between about 35% w/w and 64% w/w, preferably between 50% w/w and 60% w/w, constituting in this case the basic comonomer of the mixture.

As regards the second comonomer, the n-butyl methacrylate (CAS No. 97-88-1) is preferably used, especially due to its low toxicity and its reactivity which is not very different from the one of the MMA. The n-butyl methacrylate favors the formation of a sufficiently homogeneous polymer, thus obtaining a uniform distribution of the comonomer along the polymer chain. The use of a methacrylate with a low Tg as that of butyl methacrylate (Tg=20° C.) further allows to obtain a more flexible and more resistant to impact MMA-n-butyl methacrylate polymer than the commercial PMMA, being the latter a substantially rigid and fragile polymer, characterized by a Tg=105° C. and by a Vicat temperature of 115° C. In the present process the n-butyl methacrylate acts, in fact, as an internal plasticizer, thus allowing to obtain a polymeric mixture (or matrix) characterized by a good flexibility and a good resistance to the propagation of cracks. Due to this, by the present process it is possible to obtain a final polymeric material endowed with excellent elasticity and strength, avoiding the use of external plasticizers which, as known in the art, can migrate on the surface of the polymer, generating problems and drawbacks known to those skilled in the art. The versatility of the present process, however, also allows the possible use of additional both internal and external plasticizers, depending for example on the needs and the specific use it is intended for the final polymeric material.

In general, the second comonomer, preferably n-butyl methacrylate, is admixed with the first MMA comonomer in amounts comprised between about 10% w/w and 30% w/w, preferably between about 15% w/w and 25% w/w.

In this regard it should be noted that different amounts of the second comonomer may cause some difficulties of mass copolymerization according to the present process, or may decrease the Vicat and the Tg of the final polymeric material, making it less convenient for the implementation in particular of glass frames for sunglasses.

In an alternative embodiment, the second comonomer is a C₂-C₁₆ alkyl acrylate polymer. The use of this type of comonomer is particularly useful in the case in which the polymeric material obtained by the invention process is used to achieve objects of jewelry, such as bracelets, rings and the like.

The starting copolymers may be admixed together according to methods known in the art, forming polymeric solutions or dispersions. The mixing can take place at room temperature (defined as between about 15° C. and 40° C.), or even at higher temperatures. In this regard, the term “solution” means a mixture substantially free of precipitates or solid or semi-solid residues; unlike the term “dispersion” that, instead, includes in its meaning mixtures containing residues or traces of undissolved material. In one embodiment, the selected comonomers are admixed together and to the monomeric mixture thus obtained is then added (step b) the appropriate impact modifier polymer. The latter, in particular, is a compound capable of acting in synergy with the above second mentioned comonomer, without adversely affecting the Tg of the final polymeric material, for example by decreasingly it substantially, while conferring the necessary strength and stability.

In order to optimize this process, it is useful to add the impact modifier polymer under heating, so to facilitate the dissolution of the components of polymeric mixture that is thus formed. Therefore, in one embodiment, the mixture of the starting comonomers is heated to a temperature comprised between about 40° C. and 60° C., preferably between about 45° C. and 55° C. and then added with the selected impact modifier compound.

Advantageously, in the present process a commercially available impact modifier can be used, preferably an amorphous thermoplastic polymer, even more preferably of the mono-layer or bi-layer type, also known to those skilled in the art as “core-shell 1” and “core shell 1-2”. Preferably, the impact modifier is an acrylic-, butadiene- or silicone-based polymer, in which the elastomeric phase is mainly composed of a crosslinked copolymer preferably based on butyl acrylate, ethyl acrylate or polybutadiene. In one embodiment of the polymeric material for the use according to the invention, the selected impact modifier has a micrometric or nanometric average particle size. In this regard, “nanometric average particle size” is intended to mean particles having an average size of up to 200 nm; while the term “micrometric average particle size” is intended to mean particles having an average size up to 800 μm (microns). Even more preferably, the impact modifier polymer is selected from: butadiene polymer, block copolymer of butadiene-butyl acrylate type, butadiene-styrene type, or methyl methacrylate-butadiene-styrene type. Equally preferred are polymers “M-A-M triblock copolymer” with polybutyl methacrylate and methyl methacrylate, multilayer core/shell mainly acrylic-based pre-dispersed in PMMA. The choice can depend, for example, on the higher or lower compatibility with the starting comonomers, on the easiness of dispersion or dissolution, on the Vicat temperature, on the final viscosity of the polymeric mixture to be subjected to mass casting, or also on the refractive index which determines the higher or lower transparency of the final polymeric material. In a particularly preferred embodiment, the impact modifier is added in the form of extrusion granules, even more preferably made of PMMA containing an impact modifier predominantly acrylic-based, for example in the form of amorphous thermoplastic granules mainly composed of mixtures of polymers of methyl methacrylate, n-butyl acrylate and, in smaller quantities, styrene. Other commercially available impact modifiers are usable in the present process, such as, but not limited to, those produced by Evonik (Plexiglas® ZK6BR/ZK40 Molding compound) or those produced by Arkema (Altuglas® DRT) or by Lucite (Diakon ST45G8).

In one embodiment, the impact modifier is a polymethyl methacrylate polymer, even more preferably Plexiglas® ZK6BR, in the form of granules characterized by a Charpy impact strength of 80 kJ/m², by a tensile modulus of 1800 MPa, and a Vicat temperature of 95° C. The Plexiglas® ZK40 type is characterized by a higher impact strength but is less transparent and therefore it is preferred not only to increase the impact resistance, but also to obtain plates with a higher haze value.

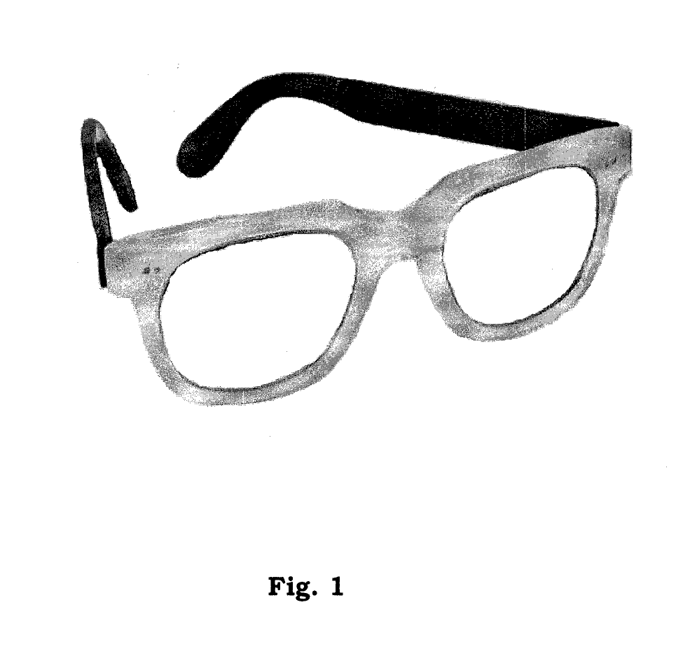

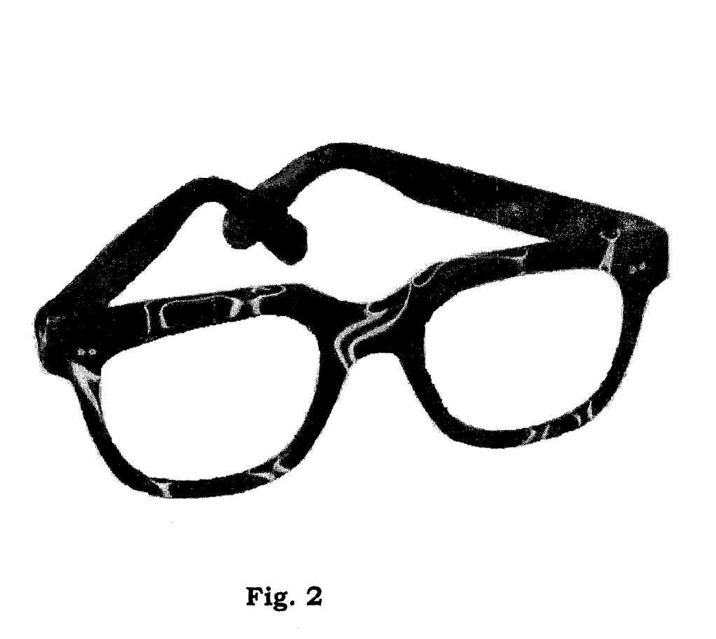

Advantageously, according to the invention, when the polymeric material obtained by the present process is intended for the preparation of glass frames, the refractive index of the impact modifier may not be a determining factor for the choice of the same, since in the specific use the final polymeric material can have opaque characteristic, or possess a certain degree of translucency or haze, as for example illustrated in FIGS. 1 and 2. This is in contrast with most of the commercially available, resistant to impact, modified polymeric plates which, on the contrary, have to contain impact modifiers with a certain refractive index since they need to be highly transparent because mainly used in windows or in similar applications.

Therefore, in a further embodiment of the polymeric material for use according to the invention, the impact modifier used in the present process is a polymeric compound having a refractive index different from that of the mixture of the starting comonomers. Advantageously, in this case, not only it is not necessary to add other compounds to balance the difference of refractive index, but, on the contrary, a small degree of haze of the material thus obtained is particularly useful to enhance the final colors and obtain special decoration and/or aesthetic effects, such as illustrated in FIG. 2. Preferably, therefore, the impact modifier polymer has a higher refractive index than the one of the mixture of comonomers. Among the impact modifiers polymers usable in the present invention, polystyrene is particularly preferred.

The amount of the selected impact modifier polymer is preferably comprised between about 5% w/w and 25% w/w, even more preferably between about 10% w/w and 20% w/w. The Applicants have noted that higher amounts may increase the expansion coefficient of the polymeric material obtained by the present process, in such a way that it may decrease the stability of the lenses, in the case in which said polymeric material were used for the realization of glass frames.

In order to optimize the viscosity of the polymeric material obtained by the present process, and at the same time in order to help improving the formability of the plate, in addition to the impact modifier at least one PMMA-based copolymer in beads can be employed, preferably selected from: methyl methacrylate-methyl acrylate/ethyl acrylate/butyl acrylate, butyl methacrylate or methyl methacrylate methacrylic acid. In this regard, suitable commercially available copolymers can be used, such as, for example, Diakon MG 100 by Lucite, or Diakon LG 156 which is a MMA-ethyl acrylate copolymer containing 12% of ethyl acrylate. In one embodiment, the selected copolymer in beads is used in quantities comprised between 0% w/w and 15% w/w, preferably between 0% w/w and 10% w/w.

The impact modifier, and optionally the PMMA-based copolymer in beads, can be directly dissolved or dispersed in the mixture of comonomers, preferably at a temperature comprised between 40° C. and about 60° C., or added to the mixture in the pre-polymerization step according to known procedures. In a preferred embodiment, the starting comonomers are admixed together, heated to a temperature between about 40° C. and 60° C., and added, preferably under vigorous stirring (500-700 rpm), with the impact modifier, and possibly with the PMMA-based copolymer in beads. The dissolution or dispersion time can be comprised between 3 and 6 hours, typically in function of the different types and quantities of the used compounds.

In order to improve the resistance of the polymeric material obtained by the present process and, more generally, in order to improve the resistance to perspiration, for example to the additives contained in face protective lotions, of glasses made with the present material, the process comprises the use of a crosslinking agent (step c). The use of at least one polymeric crosslinking agent allows to improve the surface characteristics and the impact resistance of the polymeric material obtained by the present process, allowing, also, to maintain substantially unchanged the thermo-formability of the same, especially if in the form of a plate. In practice, the polymeric crosslinker works as a kind of spring, reducing the traditional fragility which, instead, would be obtained using non-polymeric crosslinkers. Preferably, the selected crosslinking agent is used in amounts between about 0% and 1% w/w (0-10000 ppm), even more preferably between 0.1% and 0.5% w/w (1000-5000 ppm), being amounts comprised between 0.1% and 0.25% w/w (1000 and 2500 ppm) even more preferred.

Equally preferred are amounts between 0.5% w/w and 1% w/w (5000 and 10000 ppm), since such amounts allow to surprisingly increase the solvent resistance of the polymeric material thus obtained. Amounts of the polymeric crosslinker higher than 1% w/w (10000 ppm) may influence the behavior to heat of the obtained polymeric material, for example by changing the thermoplastic characteristic in thermosetting. Therefore, it is possible to realize a wide range of polymeric materials of the invention, with or without crosslinker, having different features as a function for example of the produced polymeric material plates. By way of example, if the material is used for making glass frames, there may be cases in which the front of the frame should be more flexible and impact resistant. The process of the invention may therefore contemplate the use of a modest amount of crosslinker, for example comprised between 0.1% w/w and 0.25% w/w (1000 and 2500 ppm). When, on the contrary, a high resistance to solvent must be achieved, higher amounts of crosslinker may be used, for example comprised between 0.5% w/w and 1% w/w (5000-10000 ppm).

As a preferred polymeric crosslinker, a crosslinker of the Polyethylene glycol (PEG) 200, 400, 600 or 1000 dimethacrylate type is used, whereby due to the considerable length of the polymer chain, it allows to obtain a material with improved chemical-physical characteristics, while maintaining good flexibility and impact strength. PEG 600 dimethacrylate and PEG 400 dimethacrylate, in particular, give optimum results without excessively reducing the impact resistance and are therefore preferred. In one embodiment, PEG 200, 400, 600, or 1000 dimethacrylate is used in amounts between about 0.1% w/w and 0.25% w/w thus allowing to increase the impact resistance of the final polymeric material obtained with the invention process, as shown in Table 1 herein below.

Alternatively, other polymeric crosslinkers can be used, which for the particular length or form of their molecular chain, maintain a certain degree of final flexibility such as, preferably, the polyethylene diol dimethacrylate. In order to increase the efficiency of the crosslinking action, the selected crosslinking polymer is preferably added with the polymeric mixture at a temperature comprised between about 20° C. and 30° C. Therefore, in one embodiment, the present process, for example, between step b) and step c) comprises an intermediate cooling step at the temperature indicated above.

The use of a polymeric crosslinker, in combination with the passage of thermal stability of the present process, allows to obtain a polymeric material able to be advantageously used for making objects which require a certain impact resistance, but at the same time, require a certain modifiability or shape retaining, such as, typically, glass frames. The use in the present process of one or more polymer-based crosslinkers allows to obtain a material with a good resistance to perspiration (resistance to acid) and to additives present in cosmetics, in bronzing and polishing agents, generally used in polishing and finishing of glass frames.

The absence of crosslinker, however, can find application according to the present process, in the production of a polymeric material endowed with high impact strength and/or even intended for decoration by transfer of digital images through thermal sublimation.

The Applicants have noted that in the event of an incomplete or partial crosslinking, the final step of thermal stability is equally important as it allows to prevent that traces of non-crosslinked material can potentially compromise the features of resistance and flexibility of the obtained polymeric material.

In the case of production of semi-transparent or translucent plates, the polymeric mixture, after the possible addition of the crosslinker, is preferably subjected to degassing according to methods known in the art, and then mass casting in the crosslinking mold.

In one embodiment, the polymeric mixture can be added (step d), with at least one additive useful to obtain the final desired aesthetic and/or decorative effect. Examples of additives are: dyes, pigments, coloring granules, masterbatch, dispersants, opacifiers, pigmented syrups with different viscosity, colored crosslinked polymers, molecular weight controlled colored polymers, useful for the production of colored, streaked, speckled, marbled plates, and the like. It should be noted that the addition of colored resins, pigments and/or dyes in granules is preferred as it allows to obtain variegated colorations and decorations with different degrees of mass translucency and opacity (i.e., not at the surface), creating a noticeable three-dimensional effect. In one embodiment, the mixture is mass added with natural and/or synthetic fibers, for example in the form of fabrics, nets, laces, or even plastic films, preferably PVC, obtaining in the latter case the decorative effect shown for example in FIG. 2.

Equally preferred is the addition also of refractive index polymers regulators, or also one or more additives used in radical vinyl polymerization known in the art, such as thermal stabilizers (lrganox 800), antioxidants/UV stabilizers (Tinuvin 770), release agents (Aerosol OT), UV absorbers (Tinuvin 312), reaction controllers (Terpinolene) and mixtures of azo catalysts (for example known under the trade name of Vazo 52/Vazo 64/Vazo 88 produced by DuPont), alone or in mixture thereof. Other types of free radical catalysts can be used, among which peroxides and per-esters are preferred. Also titanium dioxide is preferred, especially in the case of transfer of digital images through the thermal sublimation process since, besides favoring the penetration of the pigments, it improves the contrast with the image.

In special cases where it is necessary to obtain a material having a higher elongation at break, it is also possible to add a natural plasticizer, preferably in amounts less than 10% w/w, with high boiling temperature such as acetyl tributyl citrate. In this regard, the below Table 3 shows that the use of a natural plasticizer improves the elongation at break of the polymeric material obtained in the form of a plate. The selected additives are preferably added at a temperature comprised between 10° C. and 35° C., even more preferably between about 15° C. and 25° C. The additives may be added before the casting step, or, preferably, after, or even more preferably contextually to the casting step. In one embodiment of the polymeric material for use according to the invention, the polymeric mixture is added with a crosslinked acrylic rubber or polystyrene, before or during the casting step. The Applicants have in fact surprisingly noted that the use of the crosslinked acrylic rubber in synergy with the components of the polymeric mixture of the present process seems to create a sort of thixotropic structure that allows, during the casting, a slow diffusion through the polymeric mass, favoring the formation of deep and stable veining that determines in the plate a three-dimensional effect particularly appreciable by those skilled in the art.

The polymeric mixture according to the present process, is then mass casted, and subjected to copolymerization in the mold (step e). In one embodiment of the invention, the mass casting takes place keeping the temperature comprised between about 10° C. and 35° C., even more preferably between about 15° C. and 25° C. In this case, the polymeric mixture, characterized by high viscosity, is cooled at the above indicated temperature, and casted into molds generally constituted by glass or metal plates separated by a suitable gasket which represents the final thickness gauge. Preferably, but not limited to, the casting takes place in molds having dimensions and shapes which allow the production of plates, for example of 600×1000×10 mm dimensions. In one embodiment, the material is casted in molds which allow the production of plates having a height comprised between 3 and 16 mm. Molds having other sizes and/or shapes may, however, be used in the present process, according for example to the type of processing, or object that has to be obtained.

The casting can be done horizontally or vertically, as well as the copolymerization. Preferably, the casting and the subsequent copolymerization take place both in vertical, since, in view of the shrinking of the material during the copolymerization, it is possible to obtain a better control of the final size of the polymerized material in the form of a plate. Moreover, the vertical casting is the one that is best suited for the addition of any additives, usable for example in the production of plates with variegated colored veins, irregularly distributed in the polymeric mixture and the like as described above.

Preferably, the first stage of the copolymerization of the casted in molds resin occurs at a temperature between about 60° C. and 80° C., even more preferably in water. Alternatively, said first step can take place directly in the oven or under pressure in an autoclave. After the first step, the final copolymerization step, aimed to minimize the free monomer, occurs at a temperature between about 80° C. and 120° C., preferably in the oven. In one embodiment, the copolymerization is conducted entirely in the oven or under pressure at temperatures between about 60° C. and 120° C.

Generally, after the mass polymerization of acrylic monomers of the prior art, plates are obtained with a residual internal stress due to the shrinking of the monomers in the transition from liquid to solid. If the plates undergo a mechanical processing such as a surface grinding, to the stress of the production of the plate the one of the processing is added. Such concentration of stress not only can promote the crazing phenomena (surface micro-cracks) i.e. decreasing the resistance of the plate even the softest solvents, but could also determine the formation of true cracks (deep cracks) during the insertion of the screws of hinges in the frames production step. In addition, it is necessary to consider that the acrylic plates such as the methyl methacrylate ones and copolymers-based thereof, if heated above the transition temperature such as in the case of thermoforming, undergo a shrinking equal to about 1.5-2% for side in the case of the casted plates, which may be even higher in the case of the extruded plates. If the heating is, instead, localized in a small area, as sometimes happens in some steps of the glass frames production, localized stress may be generated, due to the contraction forces. Therefore, in order to optimize the final quality of the polymeric material subject of the innovation, i.e. in order to stabilize the plate size, to improve resistance to crazing phenomena and more particularly to perspiration and to lotions additives that can come in contact with the glasses made with the present material, to complete the crosslinking and to reduce the amount of the free monomer, the polymeric material is subjected to a step of thermal stabilization (step fi.

Said step preferably takes place by removing the material from the mold and heating at high-temperature for a time generally dependent for example on the thickness of the plate. Preferably, the polymeric material removed from the mold is heated to a temperature between about 100° C. and 140° C., even more preferably between about 110° C. and 135° C. The heat treatment, preferably carried out in the oven, can be extended up to obtain the optimum result, for example, for about 6-10 hours.

Advantageously, not only the step of thermal stabilization results in a shrinking of the longitudinal size (about 2-3%) and in an increase of the thickness, but also allows to obtain a new reorganization of the molecular structure of the polymeric material thus obtained, stabilizing it dimensionally (Preshrunk). The final material, therefore, is stable and characterized by an equilibrium condition, able to substantially eliminate the internal stress. Advantageously, the reduction of the free monomer (even up to a value lower than 0.1% w/w) that is obtained with the present process, makes possible the use of the material in the production of glass frames, presenting a high degree of biocompatibility. It should be remembered, moreover, that the polymeric material obtained by the present process when subjected to a possible future heating, undergoes no substantial shrinking, and this feature is very important not only in the case of a use in the production of glass frames, but also, in the obtained product, in the phase of normal adjustment that the optician accomplishes by heating the frame.

The stabilizing heat treatment step, therefore, contributes to characterize the present process as it allows to obtain a polymeric material having unique characteristics especially in terms of stability, internal stress, amount of the free monomer, biocompatibility and Vicat temperature. It should be noted that in the absence of said step, the obtained polymeric material, especially if crosslinked, would have different features, which would make it less convenient in terms of stability and deformability.

In other words, the Applicants have surprisingly found that the process described here gives to the obtained polymeric material intrinsic characteristics not otherwise describable. Further, the material, exhibits a resistance similar to that of PMMA, and a Vicat temperature similar to that of acetate, showing, therefore, the optimal characteristics of such polymeric materials (PMMA and acetate), without, however, showing the problems that accompany the use of said materials as explained above.

In one embodiment, the invention relates to the use of said material in the form of a plate, preferably having a thickness comprised between 3 and 16 mm, even more preferably opaque and/or colored and/or decorated, for making optical devices, preferably glass frames.

The present polymeric material is found to be biocompatible, lightweight, inexpensive, and suitable for the realization of glass frames with the usual mechanical processing methods. The obtained polymeric material, furthermore, is substantially free of toxic or easily migrant plasticizers, has a good flexibility and impact resistance, low expansion coefficient, high resistance to perspiration and to solvents and additives contained in cosmetic and sun-protective lotions.

A further advantage of the present material resides in the fact that it can be obtained both with an opaque and colored appearance, or also variously decorated. In that regard, in one embodiment, the invention relates to the use of an obtained polymeric material, preferably in the form of a plate, with the process as described above, decorated by mass decoration, or three-dimensional decoration, or by transfer of digital images through thermal sublimation for making optical devices, preferably glass frames. In that regard, the decoration by thermal sublimation not only allows to obtain the present material with surprising stable in time decorations, but it also allows a considerable simplification in the processing and therefore a reduction in costs. Currently, in fact, the transfer of digital images through sublimation is carried out in the prior art, on small pieces or by injection, directly on the mold. According to the prior art, furthermore, the image protection, when it is not made with a coating, is carried out predominantly for direct lamination by heating or by the use of solvents, plasticizers, high pressure and high temperature adhesives.

In an alternative embodiment, the invention relates to the use of a polymeric material obtained by the process as described above, mass decorated for the realization of optical devices, preferably glass frames. The methodology of mass coloring and/or decoration allows to obtain the material with three-dimensional effects, characterized by a wide range of varied colors, with veins, iridescence, marble, pearlescent, luminescent effects etc. This range is extended with the production, preferably of plates obtained by incorporating (e.g. in step d) fabrics, nets, laces, plastic films etc. Special effects are also obtained by adding to the polymeric mixture to be subjected to polymerization glitter, colored polymeric granules, crosslinking and molecular weight controlled polymer flakes and/or pigments, according to the methodologies of the mold casting technique.

Preferably, in this regard, differently viscous or colored resins can be used, pigments or dyes, dispersants, thixotropic, fluorescent, iridescent, pearlescent compounds, slow dissolution colored granules and the like. Advantageously, in addition to achieve a variety of decorations in terms of shapes and colorations, the present decorated polymeric material is obtained substantially without the use of solvents, with very reduced time and production costs.

Further characteristics and advantages of the polymeric material, subject of the use according to the invention, are:
lightweight (specific weight <1.18 g/cm³);
speed of water absorption <0.30% (water absorption in 24 hours, method ASTM 570, much lower than that of cellulose acetate >2%) which allows dimensional stability and possibility of storage of the plates without pre-heating before use;
absence of phthalate-based plasticizers, that permits to the polymer to largely maintain its properties over time, to be able to realize glasses with polycarbonate lenses without the risk that surface crazing is formed on the lens;
relatively low coefficient of linear expansion 8×10⁻⁵ 1/K (0.08 mm/m ° C.) in any case lower than the one of the cellulose acetate plates used in the realization of the frames (10-15)×10⁻⁵ 1/K, guarantees the stability of the lenses with different thermal excursions;
Charpy impact strength 28.9 KJ/m² (about twice that of PMMA);
elongation at break 12.3% (more than double that of PMMA (4-5.5%));
high resistance to ultraviolet radiation;
negligible residual memory (meaning the ability to retain its shape over time);
ease of adjustment by heating at relative low temperature;
good resistance to cosmetic lotions, to polishing used for the cleaning and polishing of the glasses, and to perspiration as well as specifically required by regulations;
low tendency to give allergic dermatitis: the absence of plasticizers which migrate the mass coloration and suitable to heat treatments to complete the polymerization minimizes the presence of the free monomer to values even less than 0.1% w/w;
negligible dimensional shrinking (Preshrunk) at the sublimation temperature of 180-190° C., makes optimal the image transfers on the surface of the plate through the thermal sublimation process.

The polymeric material, obtained with the present process, is also characterized by a relatively low Vicat temperature, comprised between about 75° C. and about 85° C. It should be noted that this temperature allows the realization of glass frames also usable in the summer times (typically sunglasses) without suffering deformation or changes in the chemical-physical behavior, as it would be the case when using similar materials having a lower Vicat temperature. A Vicat temperature of about 80° C. as the one of the plate subject of the invention allows, in fact, to realize glass frames stable enough at room temperature and at the same time to thermoform the material in the form of a plate at temperature of about 100-120° C. differently from a temperature higher than 160° C. as used for the casted PMMA, and higher than 140° C. for forming the plates of impact modified PMMA.

Tables 1 and 2 show a comparison between some properties of commercially available casted PMMA plates, and a plate subject of the use according to the invention, where the improvement of flexibility in elongation at break and the impact strength of the latter appear evident. Generally, the crosslinking of a polymeric matrix causes the formation of a three-dimensional structure with a limited degree of freedom that while favoring a better resistance to solvents, normally makes the plate more fragile significantly reducing the impact strength. In this case the use of a high molecular weight polymeric crosslinker used in optimal amount has allowed the improvement of the surface characteristics of the plate, in particular the resistance to perspiration, to the additives of protective lotions, to the polishing used for frames polishing, without reducing the impact strength but, on the contrary, improving it.

In one aspect, the invention relates to the use of the present material, preferably in the form of a plate, for the preparation of lens frames, preferably in the form of glasses. The latter, in particular, can be glasses, for work or also glasses containing or not optical lenses, corrective lenses (for example, to correct myopia, astigmatism and/or presbyopia), protective lenses and/or sun lenses. Preferably, the present material is used in the preparation of frames for prescription glasses and/or sunglasses, even more preferably opaque, colored and/or decorated.

Due to the chemical-physical characteristics of the material subject of the invention, all kinds of lens can substantially be used, such as safety glass, polycarbonate or the like. Therefore, the invention also relates to a glass comprising a frame made with this material.

Equally preferred is the use of the present polymer material for the realization of jewelry. The extreme versatility of the present material, in fact, allows its use also for the realization of a series of objects of jewelry and accessories having hue and aesthetic effects adaptable to different uses and market trends. Examples of such objects can be bracelets, studs for shoes, for bags etc.

The present invention will now be described with the following experimental part, without however to limit its scope.

### EXPERIMENTAL PART

### Example 1

Preparation of a Colorless Translucent Crosslinked Plate, Having 10 mm Thickness Using the Invention Process Described Above.

The composition of the casted polymeric mixture is the following:

| | |
|---|---|
| Methyl methacrylate | 51.5% |
| n-butyl methacrylate | 25% |
| Polyethylene glycol 600 dimethacrylate | 0.2% (2000 ppm) |
| Impact modifier (plexiglass ZK6BR) | 20% |
| Copolymer MMA/acrylate (DIAKON MG100) | 3% |
| Tinuvin 770 | 250 ppm |
| Tinuvin 312 | 1000 ppm |
| Irganox B800 | 500 ppm |
| Terpinolene | 50 ppm |
| Vazo 52 (Dupont) | 30 ppm |
| Vazo 64 (Dupont) | 140 ppm |
| Vazo 88 (Dupont) | 500 ppm |
| Aerosol OT | 450 ppm |

The plate is obtained after mass casting and polymerization in tank at a temperature of 60-80° C., and subsequent completion of the polymerization in an oven at 100-120° C.

The stabilizing heat treatment step takes place in the oven at a temperature comprised between 110 and 135° C. on the plate removed from the mold. The addition to the basic formulation of small amounts of polystyrene in granules (0.2-1%) even more reduces the transparency allowing to obtain plates with a degree of translucency similar to that of Celluloid. From Table 1, where the mechanical characteristics of the plate after the adjustment and the high-temperature heat treatment are indicated, it appears that, despite the crosslinking, the impact resistance is not substantially modified but it is indeed increased by about 10% compared to that of the not crosslinked plate. In addition, the elongation at break (12.3%) and the impact strength (28.9 kJ/m²) of the plate of Example 1 are respectively around three and two times the average values of commercial casted PMMA. In special cases where it is necessary to produce a plate characterized by a higher elongation at break, it is also possible to use a natural plasticizer (6%) with high boiling temperature such as acetyl tributyl citrate. In this case, we obtain values for elongation at break (ASTM 0638)>15% but a reduction in the impact resistance compared to that of the plate without the external plasticizer, as shown for example in Table 3.

### Example 2

Preparation of a Non-Crosslinked Semi-Transparent Colorless Plate Having 10 mm Thickness Using the Process Described Above.

The composition of the casted polymeric mixture is the following:

| | |
|---|---|
| Methyl methacrylate | 52% |
| n-butyl methacrylate | 25% |
| Impact modifier (plexiglass ZK6BR) | 20% |
| Copolymer MMA/acrylate (DIAKON MG100) | 3% |
| Tinuvin 770 | 250 ppm |
| Tinuvin 312 | 1000 ppm |
| Irganox B800 | 500 ppm |
| Terpinolene | 50 ppm |
| Vazo 52 (Dupont) | 30 ppm |
| Vazo 64 (Dupont) | 140 ppm |
| Vazo 88 (Dupont) | 1000 ppm |
| Aerosol OT | 450 ppm |

The plate is obtained after mass casting and polymerization in a tank at a temperature of 60-80° C., and subsequent completion of the polymerization in an oven at 100-120° C.

The stabilizing heat treatment step takes place in the oven at a temperature comprised between 110 and 135° C. on the plate removed from the mold. The not crosslinked plate has been produced to control the influence of the crosslinker on the impact strength, and to determine the residual free monomer. The value of the impact resistance (Charpy ISO 179/lfU) as seen in Table 2 of about 25 KJ/m² is less than the one of the crosslinked plate (28.9 KJ/m²) confirming that when the crosslinker concentration is contained within 2500 ppm, it does not reduce the impact strength, but improves it. On the contrary, concentrations higher than 5000 while greatly improving the solvent resistance progressively reduce the impact resistance. In Table 3 it is also evident the higher impact resistance compared to that of the commercially available casted PMMA.

Equally, the Vicat temperature (81° C.) being less than that of PMMA (115° C.) indicates a greater formability at relatively lower temperatures and therefore facilitates the processing of the plate in the realization of the frames. The very low free monomer content (<0.1% determined by gas chromatography) is an important value for the hypoallergenicity of the plate.

### Example 3

Preparation of Plates with Mass Colored Veins for Use According to the Invention

The polymeric mixture of Example 1 is mass colored with a transparent colorant and is slowly poured into the mold, held vertically, simultaneously to other two resins of the same basic composition, but which differ in the viscosity and coloring. Preferential paths of the colored resins are formed in this way that are spread slightly in the mass creating imaginative veins. Equally, plates with variegated decorations can be obtained adding slow dissolution colored granules and/or PVC plastic films.

### Example 4

Preparation of an Opaque Plate with 6 mm Thickness Usable in the Transfer of Images Through Thermal Sublimation

The plate is produced without crosslinker in order to facilitate the penetration of the image. The composition of the casted polymeric mixture is the following:

| Methyl methacrylate | 55% | |
|---|---|---|
| n-butyl methacrylate | 25% | |
| Impact modifier ZK6BR (Evonik) | 15% | |
| Copolymer MMA/acrylate (DIAKON MG100) | 6% | |
| Irganox B800 | 500 | ppm |
| Tinuvin 770 | 280 | ppm |
| Tinuvin 312 | 1000 | ppm |
| Aerosol OT | 380 | ppm |
| Vazo 52 (Dupont) | 120 | ppm |
| Vazo 64 (Dupont) | 210 | ppm |
| Vazo 88 (Dupont) | 500 | ppm |
| Terpinol | 50 | ppm |
| Pre-dispersed titanium dioxide | 16 | g/kg |

The plate is obtained after mass casting and polymerization in a tank at a temperature of 60-80° C., and subsequent completion of the polymerization in an oven at 100-120° C.

The stabilizing heat treatment step takes place in the oven at a temperature comprised between 110 and 135° C. on the plate removed from the mold. After the heat treatment, the plate is used for the transfer of digital images through thermal sublimation procedure. Interesting effects are obtained also by using transparent, translucent or differently colored or pigmented plates.

### Example 5

Comparative Tables

TABLE 1
Physical properties of the crosslinked plate obtained in
Example 1, in comparison with those of commercially available
acrylic plates (PMMA).

| | | MATERIALS | |
|---|---|---|---|
| | | | COMMERCIALLY |
| | | CROSSLINKED | AVAILABLE |
| | | PLATE | ACRYLIC |
| TYPE OF TEST | UNIT | (EXAMPLE 1) | PLATES |
| Tensile stress at | MPa | 51.5 | 77 |
| yield ASTMD638 | | | |
| Elongation at yield | % | 4.66 | — |
| ASTMD638 | | | |
| Stress at break | MPa | 43 | 77 |
| ASTMD638 | | | |
| Elongation at break | % | 12.3 | 4-5.5 |
| ASTMD638 | | | |
| Tensile modulus | MPa | 2600 | 3200-3300 |
| ASTMD638 | | | |
| Charpy impact | KJ/m² | 38.7 | — |
| strength without | | | |
| notch ASTMD256 | | | |
| Charpy impact | KJ/m² | 28.9 | 11-15 |
| strength without | | | |
| notch ISO179/1fu | | | |
| Shrinking at 160° C. | % | No shrinking | 2 |

TABLE 2
Chemical-physical properties of the not crosslinked plate
obtained in Example 2, in comparison with those of commercially
available acrylic plates (PMMA).

| | | MATERIALS | |
|---|---|---|---|
| | | | COMMERCIALLY |
| | | CROSSLINKED | AVAILABLE |
| | | PLATE | ACRYLIC |
| TYPE OF TEST | UNIT | (EXAMPLE N. 2) | PLATES |
| Charpy impact | KJ/m² | 25.18 | 11-15 |
| strength without | | | |
| notch ISO179/1fu | | | |
| Shrinking at 160° C. | % | No Shrinking | 2 |
| Free Monomer | % | <0.1 | 0.5-1.5 |
| Vicat Temperature | ° C. | 81 | >110 |
| ASTM D1525-09 | | | |

TABLE 3
Physical properties of a crosslinked plate of the invention
obtained with the polymeric mixture of Example 1, added with
PEG600 (0.2% and 0.5%) and with PEG600 (0.2%) and acetyl
tributyl citrate (6%).

| | | MATERIALS | | |
|---|---|---|---|---|
| | | | Polymeric | |
| | | | mixture | |
| | | Polymeric | Example 1 + | Polymeric |
| | | mixture | PEG600 | mixture |
| | | Example 1 + | (0.2%) + | Example 1 + |
| | | PEG600 | CITRATE | PEG600 |
| TYPE OF TEST | UNIT | (0.2%) | (6%) | (0.5%) |
| Tensile stress at | Pa | 51.5 | 44 | n.a. |
| yield ASTMD638 | | | | |
| Elongation at yield | % | 4.66 | 4.26 | n.a. |
| ASTMD638 | | | | |
| Stress at break | Pa | 43.3 | 30.6 | n.a. |
| ASTMD638 | | | | |
| Elongation at | % | 12.3 | 16 | n.a. |
| break ASTMD638 | | | | |
| Tensile modulus | MPa | 2600 | 2200 | n.a. |
| ASTMD638 | | | | |
| Charpy impact | KJ/m² | 38.7 | 32.7 | n.a. |
| strength without | | | | |
| notch ASTMD256 | | | | |
| Charpy impact | KJ/m² | 28.9 | 24.1 | 21.3 |
| strength without | | | | |
| notch ISO179/1fu | | | | |

n.a.: not available.

The values indicated in Table 3 show that the plasticizer improves the elongation at break of the plate, resulting in a reduction of the impact resistance (>20% ref. Charpy ISO 179/1fU).

1.-18. (canceled)

19. A glass frame comprising a polymeric material based on a copolymer of methyl methacrylate and a C₂-C₁₆ alkyl acrylate or methacrylate and an impact modifier polymer.

20. The glass frame according to claim 19, wherein the polymeric material is prepared by the process of mass casting and the copolymerization of a methyl methacrylate comonomer and a second comonomer C₂-C₁₆ alkyl acrylate or methacrylate, in the presence of an impact modifier polymer; the process further comprising a step of thermal stabilization at a temperature of between 100° C. and 140° C.

21. The glass frame according to claim 20, wherein the process comprises:
a) mixing of a methyl methacrylate comonomer with a second comonomer selected from C₂-C₁₆ alkyl acrylate and methacrylate;
b) adding an impact modifier polymer, optionally at a temperature of between 40° C. and 60° C.;
c) optionally adding a crosslinking agent;
d) optionally adding a coloring and/or opacifying and/or decorative effect additive;
e) mass casting of the polymeric mixture thus obtained, and subsequent copolymerization, optionally at a temperature of between 60° C. and 120° C.; and
f) stabilizing heat treatment of the polymeric material obtained as a result of step e) at a temperature of between 100° C. and 140° C.

22. The glass frame according to claim 21, wherein the second comonomer is a C₂-C₁₆ alkyl methacrylate.

23. The glass frame according to claim 21, wherein the second comonomer is n-butyl methacrylate.

24. The glass frame according to claim 21, wherein the methyl methacrylate comonomer is admixed with the second comonomer in amounts of between 35% w/w and 64% w/w.

25. The glass frame according to claim 21, wherein the second comonomer is admixed with the methyl methacrylate comonomer in amounts of between 10% w/w and 30% w/w.

26. The glass frame according to claim 20, wherein the impact modifier polymer is an amorphous thermoplastic polymer of the mono-layer or bi-layer type.

27. The glass frame according to claim 20, wherein the impact modifier polymer is an acrylic-, butadiene- or silicone-based polymer, in which the elastomeric phase is mainly constituted by a crosslinked copolymer optionally selected from the group consisting of butyl acrylate-, ethyl acrylate- and polybutadiene-based copolymers.

28. The glass frame according to claim 21, wherein the crosslinking agent is a polymeric crosslinker, optionally selected from the group consisting of: polyethylene glycol 200, 400, 600 and 1000 dimethyl acrylate.

29. The glass frame according to claim 21, wherein the crosslinking agent is added in amounts of between 0% w/w and 1% w/w, or between 0.1% w/w and 0.25% w/w.

30. The glass frame according to claim 21, wherein said coloring and/or opacifying and/or decorative effect additive is selected from: dyes, pigments, coloring granules, masterbatch, dispersants, opacifiers, pigmented syrups, colored polymers or resins, natural and/or synthetic fibers, plastic films, and mixtures thereof, wherein said natural and/or synthetic fibers are optionally mass added.

31. The glass frame according to claim 20, wherein the copolymerization is carried out at a temperature of between 60° C. and 120° C.

32. The glass frame according to claim 21, wherein the stabilizing heat treatment occurs at a temperature of between 110° C. and 135° C.

33. The glass frame according to claim 20, wherein the polymeric material is obtained in the form of a plate.

34. The glass frame according to claim 33, wherein the plate has a thickness of between 3 and 16 mm.

35. The glass frame according to claim 20, wherein the polymeric material is decorated, optionally by means of: a mass decoration, or a three-dimensional technique, or by transfer of digital images through thermal sublimation.

36. Sunglasses having a frame made prepared by the process of claim 20.
